(19) United States
(12) Patent Application Publication
(10) Pub. No.: US 2026/0194675 A1
(43) Pub. Date: Jul. 9, 2026

(54) SEISMIC DATA PROCESSING METHOD, SEISMIC SURVEY PROCESS, RELATED SYSTEM AND INSTALLATION

(71) Applicant: TotalEnergies OneTech, COURBEVOIE (FR)

(72) Inventors: Stephen SECKER, PAU CEDEX (FR); Jean-Patrick MASCOMERE, PAU CEDEX (FR)

(73) Assignee: TotalEnergies OneTech, COURBEVOIE (FR)

(21) Appl. No.: 19/133,598

(22) PCT Filed: Nov. 29, 2022
(86) PCT No.: PCT/IB2022/000696

§ 371 Date: May 28, 2025

(51) Int. Cl. G01V 1/30

(52) U.S. Cl. CPC G01V 1/307; G01V 2210/1293; G01V 2210/1297; G01V 2210/324; G01V 2210/43

(57) ABSTRACT

A seismic data processing method comprises transforming an at least one common receiver gather in the time-offset domain to obtain a grid in a frequency-wavenumber domain; calculating and applying a Doppler correction filter value at each point of the grid in the frequency-wavenumber domain; inverse transforming the grid in the frequency-wavenumber domain to the time-offset domain to obtain a Doppler corrected common receiver gather; and processing the corrected Doppler common receiver gather to obtain at least a representation or/and a measurement of at least a ground feature using the Doppler corrected common receiver gather. The method may further include calculating and applying a Doppler correction filter value by determining an instantaneous frequency function of at least one of the sweeps emitted by the source, inverting the instantaneous frequency function to obtain an inverse frequency function, and calculating the Doppler correction filter value from the inverse frequency function.

### CROSS REFERENCE TO RELATED APPLICATIONS

The present application is a U.S. National Phase application under 35 U.S.C. § 371 of International Patent Application No. PCT/IB2022/000696 filed Nov. 29, 2022. The entire contents of which are hereby incorporated by reference.

### FIELD

The present invention concerns a seismic data processing method, carried out using a seismic data processing system, the seismic data being data received by at least one receiver during a relative movement of a vibratory seismic source with regards to the at least one receiver, the method comprising:
retrieving at least a common receiver gather acquired at the at least one receiver, the common receiver gather resulting from reflections in a ground of successive sweeps emitted by the source, the successive sweeps being emitted at different offsets between the at least one receiver and the source; and for the or each common receiver gather:
transforming the at least one common receiver gather in the time-offset domain to obtain a grid in a frequency-wavenumber domain;
calculating and applying a Doppler correction filter value at each point of the grid in the frequency-wavenumber domain;
inverse transforming the grid in the frequency-wavenumber domain to the time-offset domain to obtain a Doppler corrected common receiver gather; the method further comprising:
processing the or each corrected common receiver gather to obtain at least a representation or/and a measurement of at least a ground feature using the or each corrected common receiver gather.

Such a method is in particular applied to process data collected in marine seismic surveys conducted with a marine vibrator.

### BACKGROUND

Seismic surveys of the ground at a bottom of a body of water can be conducted by laying receivers made of independent nodes on the bottom of the body of water (Ocean Bottom Nodes), and by moving a vibrating seismic source at the surface or in the body of water around the survey area.

In a variant, the receivers are optic fiber cables (Ocean Bottom Sensors) laid on the bottom of the body of water to sense data via distributed acoustic sensing (DAS). In another variant, the receivers are mounted along a cable towed by a moving ship in a streamer configuration.

The marine vibrator emits successive acoustic signals or “sweeps”, which propagate through the body of water, into the ground, and which then reflect against boundaries between layers in the ground. The reflected signals are captured by each receiver to form common receiver gathers, which can be processed to obtain a representation of ground features, such as geological boundaries between geological layers in the ground.

In the past years, marine vibrators have regained the attention of the seismic acquisition community, owing in part to its accurate waveform control and potential to reduce the environmental footprint of a seismic survey over standard air guns technology.

One of the key technical challenges associated to marine vibrator processing is the compensation of the Doppler effect incurred by the movement of such a non-impulsive source in comparison to an impulsive source such as an air gun.

Indeed, an air gun quasi-instantaneously emits the exciting signal at each impulsion, as opposed to a sweep of a marine vibrator for which the energy is spread through time and space over a few seconds.

This problem has been discussed for a long time with different ways of approaching it. Known solutions to solve the problem propose to compensate for Doppler effect with specially tailored 2D convolutions.

Other recent solution such as developed by Qi and Hilterman (SEG International Exposition and 86th Annual Meeting, 2016) and Secker (83rd EAGE Annual Conference & Exhibition, 2022), is to correct the signals in the 2D Fourier domain with a dephasing operator based on the explicit analytical formula of the source waveform (by assuming either linear or exponential sweeps).

Such a method is not entirely satisfactory. Indeed, the explicit analytical formula of the source waveform sweeps must be known beforehand. However, some sweeps are not analytically defined. Even if the sweeps are analytically defined, there may be variations between the predefined theoretical sweeps and the actual sweeps produced in successive seismic surveys.

One aim of the invention is thus to obtain a seismic data processing method based on data obtained with little environmental footprint, which is simple to use yet very accurate, even if the sweeps from the seismic source are not analytically characterized or are different from a theoretical predefined sweep.

### SUMMARY

To this aim, the subject matter of the invention is a seismic data processing method of the above mentioned type, characterized in that calculating and applying a Doppler correction filter value comprises determining an instantaneous frequency function of at least one of the sweeps emitted by the source, inverting the instantaneous frequency function to obtain an inverse frequency function, and calculating the Doppler correction filter value from the inverse frequency function.

The method according to the invention may comprise one or more of the following features, taken solely, or according to any combination of technical feasible feature(s):
the sweeps are monotonic with respect to time and frequency;
the sweeps lack an analytical definition;
determining an instantaneous frequency function comprises retrieving a measured or reconstructed sweep signature including an amplitude of the seismic emission signal as a function of time during the sweep, and determining the instantaneous frequency function from the measured or reconstructed sweep signature;
the sweep signature is a measured sweep signature, measured during the actual sweep emission from a sensor within the source, for example an accelerometer or a piston movement measuring sensor, or/and from a sensor external to the source, for example a near field hydrophone;
calculating and applying a Doppler correction filter value comprises applying a filter to a raw instantaneous frequency function to remove non monotonic behavior and negative frequencies;
calculating and applying a Doppler correction filter value comprises carrying out an additional edge correction to the instantaneous frequency function to obtain at least an extrapolated edge of the instantaneous frequency function;
inverting the instantaneous frequency function comprises inverting the instantaneous frequency function in a given frequency range ranging from a starting sweep frequency to an ending sweep frequency, and setting a nil value to the inverse frequency function, outside of the given frequency range;
inverting the instantaneous frequency function comprises obtaining discrete inverse points of the inverse frequency function from corresponding points of the instantaneous frequency function and extrapolating additional points between at least two adjacent discrete inverse points of the inverse frequency function;
the Doppler correction filter value is calculated from a relative speed of movement of the source with regards to the at least one receiver;
the Doppler correction filter value is calculated at each point (f, k) of the grid via the equation 2.π.S.k.F⁻¹(f); where S is the source speed, k is the wavenumber at the point (f, k), f is the frequency at the point (f, k) and F⁻¹(f) is the value of the inverse frequency function at the frequency f at the point (f, k);
the method comprising a step of pre-processing the common receiver gather before and/or after applying the Doppler correction filter value and before processing the or each Doppler corrected common receiver gather;

The invention also concerns a seismic survey process, the seismic survey process comprising:
moving a vibratory seismic source in relation to at least one receiver;
emitting successive sweeps via the source;
acquiring at the at least one receiver, a common receiver gather from the successive sweeps;
carrying out the method as defined above.

The seismic survey process may comprise the feature by which the source is moved at the surface or in a body of water, the at least one receiver laying on a bottom of the body of water or floating in the body of water, the at least one ground feature being below the bottom of the body of water.

The invention also concerns a seismic data processing system configured to process seismic data, the seismic data being received by at least one receiver during a relative movement of a vibratory seismic source with regards to the at least one receiver, the system comprising:
a retrieving module configured to retrieve at least a common receiver gather acquired at the at least one receiver, the common receiver gather resulting from reflections in a ground of successive sweeps emitted by the source, the successive sweeps being emitted at different offsets between the at least one receiver and the source;
a first transforming module configured to transform the at least one common receiver gather in the time-offset domain to obtain a grid in a frequency-wavenumber domain;
a Doppler correction module configured to calculate and apply a Doppler correction filter value at each point of the grid in the frequency-wavenumber domain;
a second transforming module configured to inverse transform the grid in the frequency-wavenumber domain to the time-offset domain to obtain a Doppler corrected common receiver gather;
a processing module configured to process the or each Doppler corrected common receiver gather to obtain at least a representation or/and a measurement of at least a ground feature using the or each Doppler corrected common receiver gather;
characterized in that the Doppler correction module is configured to determine an instantaneous frequency function of at least one of the sweeps emitted by the source, to invert the instantaneous frequency function to obtain an inverse frequency function, and to calculate the Doppler correction filter value from the inverse frequency function.

The invention similarly concerns an acquisition seismic installation comprising:
a vibratory seismic source, configured to emit successive sweeps;
at least one receiver, configured to acquire at least a common receiver gather resulting from reflections in a ground of successive sweeps emitted by the source, the vibratory seismic source being movable with regards to the at least one receiver to emit the successive sweeps at different offsets between the at least one receiver and the source;
a data processing system as defined above.

### BRIEF DESCRIPTION OF THE DRAWINGS

The invention will be better understood, based on the following description, given solely an example made in reference to the appended drawings, in which:

FIG. 1 is a schematic view of a first seismic acquisition installation according to the invention, operating in a body of water, using nodes laid on the bottom of the body of water;

FIG. 2 is a schematic view of a seismic data processing system according to the invention, configured to process data collected by the installation of FIG. 1;

FIG. 3 is a view similar to FIG. 2 of another seismic acquisition installation according to the invention, using optic fiber cables laid on the bottom of the body of water;

FIG. 4 is a view similar to FIG. 2 of another seismic acquisition installation according to the invention, using a streamer cable floating in the body of water;

FIG. 5 is a view (a) of a simplistic raw common receiver gather acquired at a given receiver of the installation of FIG. 1, 3 or 4, after a source has moved across the receiver, in which a Doppler effect is observable, (b) of a raw common receiver gather theoretically simulated using a non-moving source, the raw common receiver gathers of (a) and (b) having then been subsequently correlated with the pilot sweep, (c) of the difference between the curves (a) and (b);

FIG. 6 is a view of a measured sweep signature of the sweeps emitted by the source;

FIG. 7 is a curve of a raw instantaneous frequency function obtained from the sweep signature of FIG. 6;

FIG. 8 is a view similar to FIG. 7, after applying a filter to manage the potential non monotonic nature of the raw instantaneous frequency function shown in FIG. 7;

FIG. 9 is a view similar to FIG. 7, after extrapolating the edges of the instantaneous frequency function;

FIG. 10 is a curve of an inverse frequency function, obtained from the instantaneous frequency function of FIG. 9, and completed with nil values outside of the sweep frequency range;

FIG. 11 is a view (a) of a simplistic corrected common receiver gather, after application of the Doppler correction filter according to the invention (b) of a raw common receiver gather theoretically simulated using a non-moving source, the raw common receiver gathers of (a) and (b) having then been subsequently correlated with the pilot sweep, (c) difference between the curves (a) and (b); and

FIG. 12 is a flow chart of an example of a processing method according to the invention.

### DETAILED DESCRIPTION

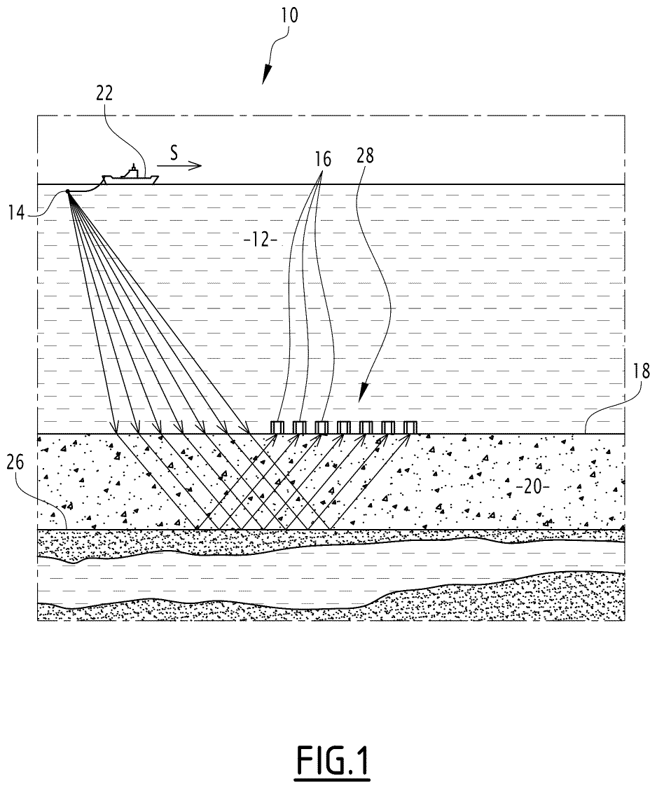

A processing method according to the invention is carried out during or after a seismic acquisition survey conducted in a body of water 12 via a seismic acquisition installation 10 for example shown in FIG. 1, 3, or 4.

The body of water 12 is for example a sea, an ocean, a lake and/or a river. The depth of the body of water 12 at the location at which the seismic acquisition survey is carried out is for example comprised between 10 m and 3000 m.

The seismic acquisition installation 10 comprises at least a movable vibratory seismic source 14, able to emit successive sweeps at various positions in the body of water 12, the sweeps propagating into the body of water 12 and into the ground 20 below the body of water 12.

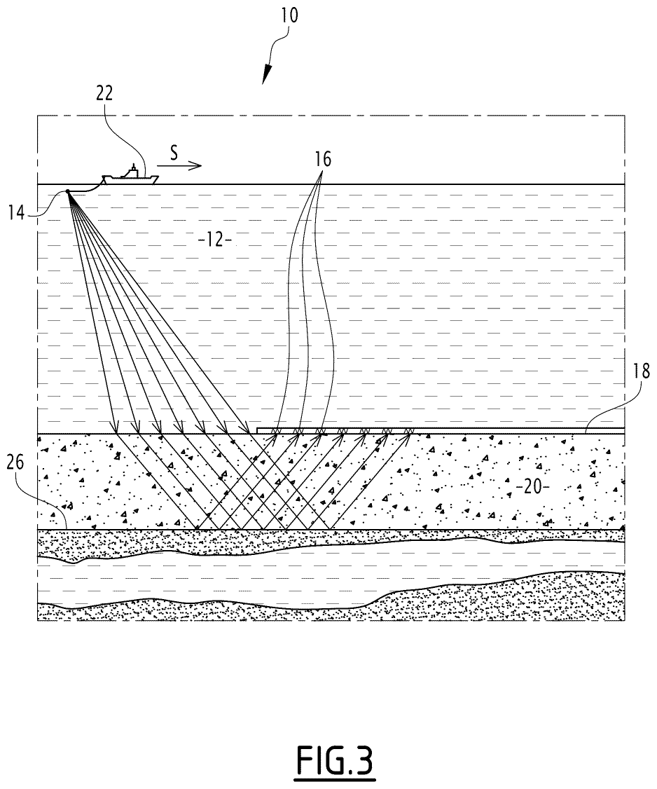

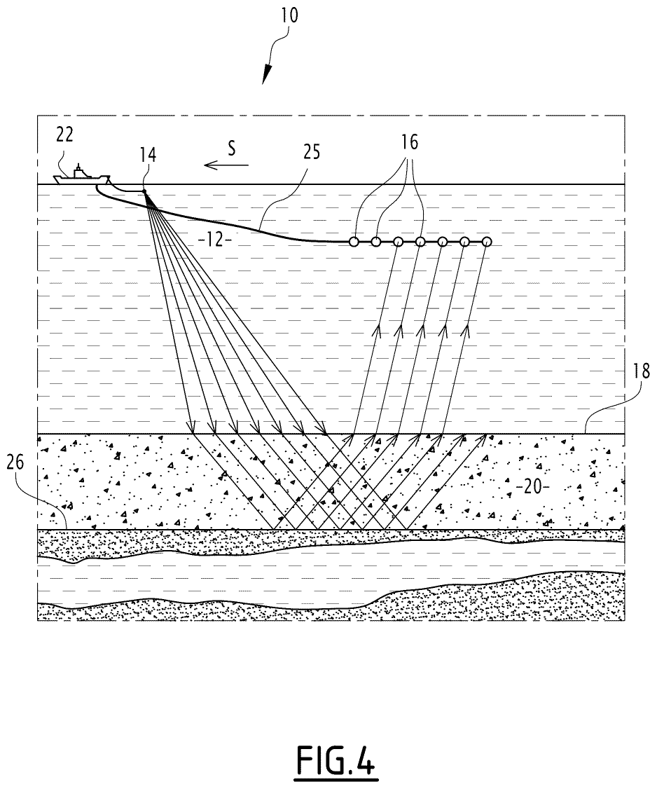

The seismic acquisition installation 10 also comprises receivers 16, positioned at the bottom 18 of the body of water 12 in the example of FIGS. 1 and 3 or floating in water in the example of FIG. 4. The sensors receive seismic signals resulting from reflections of the sweeps into features of the ground 20 below the body of water 18.

In the embodiment of FIGS. 1, 3 and 4, the seismic source 14 is moved at the surface of the body of water 12, or/and in the body of water 12. The installation 10 then comprises a source boat 22, to which the source 14 is attached. The source boat 22 is able to move the source 14 with regard to the receivers 16 at a given speed S.

The seismic source 14 is here a marine vibrator. It comprises at least a transducer, able to emit successive sweeps forming acoustic waves propagating into the body of water 12 to the bottom 18, and into the ground 20. The marine vibrator is for example an integrated projector node. It emits sweeps for example via a back and forth movement of a membrane or of a piston plate.

Each sweep has a duration generally comprised between 5 s and 30 s.

The sweep is monotonic with respect to time and frequency. This means that the variation of the frequency continuously increases or decreases during the sweep. For each sweep, a bijective relationship exists between time and frequency.

The sweep is for example a non-analytically defined sweep. In any case, even if the sweep is analytically defined, its analytical definition is not needed for carrying out the processing method according to the invention.

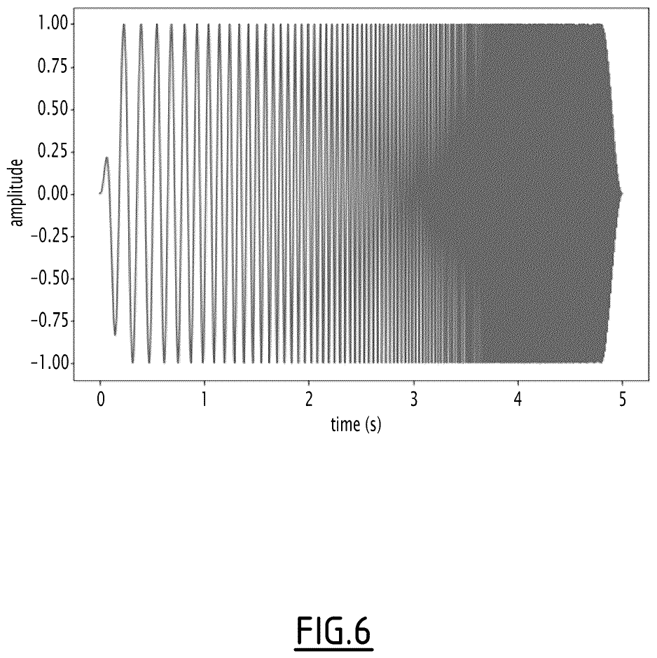

The source 14 advantageously comprises at least a sensor (not shown) able to measure a sweep signature 21 (see FIG. 6) corresponding to the amplitude of the emitted signal as a function of time during a sweep. Such a measurement is for example carried out by measuring a movement of a moving part of the transducer, such as a piston or a membrane.

In a variant, a sensor external to the source 14 is provided to measure the sweep signature 21.

The sweep signature 21 is therefore available as an input of the processing method according to the invention.

In the example of FIG. 1, the receivers 16 are nodes configured to collect and store all the signals received along time. In 3D mode, the nodes are laid on the sea floor and shots are taken over the receivers 16 with different possible configurations (parallel, cross lines or carpet shooting).

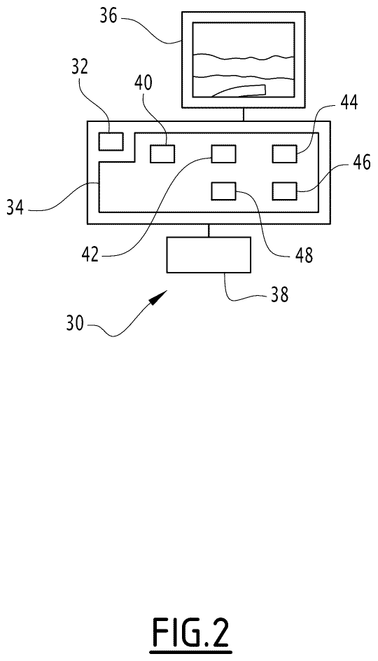

In a variant shown in FIG. 3, the receivers 16 are distributed acoustic sensing zones along optic fiber cables. Optically interrogated, the optical fiber cables are advantageously able to transmit the received signals in real time to a data storage unit or/and to a seismic data processing system 30 shown in FIG. 2.

In another variant shown in FIG. 4, the receivers 16 are mounted along at least a cable 25 towed by the source boat 22 above the bottom 18 of the body of water 12, or by another boat.

In the example of FIGS. 1 and 3, the receivers 16 are laid on the bottom 18 of the body of water 12. Advantageously, the installation 10 comprises at least a line 28 of several receivers 16 placed at the bottom 18 of the body of water 12 or a carpet of receivers 16 made of lines 28 and cross lines intersecting the lines 28. The source 14 is then moved along the lines 28 of receivers 16, parallel to the lines 28 of receivers 16 or along cross lines.

Each receiver 16 has a seismic sensor able to acquire reflected signals from the ground 20. The reflective signals result in particular from geological boundaries 26 between layers of the grounds as schematically shown in FIGS. 1, 3 and 4.

In particular, each receiver 16 is able to receive successive seismic signals resulting from reflections of successive sweeps of the source 14 during the relative moving between the source 14 and the receiver 16.

Each receiver 16 is able to timestamp the received signals such that for each offset of the source 14 with regard to the receiver 16, a reception time from the emission of the sweep to the reception of the reflected signal is measured.

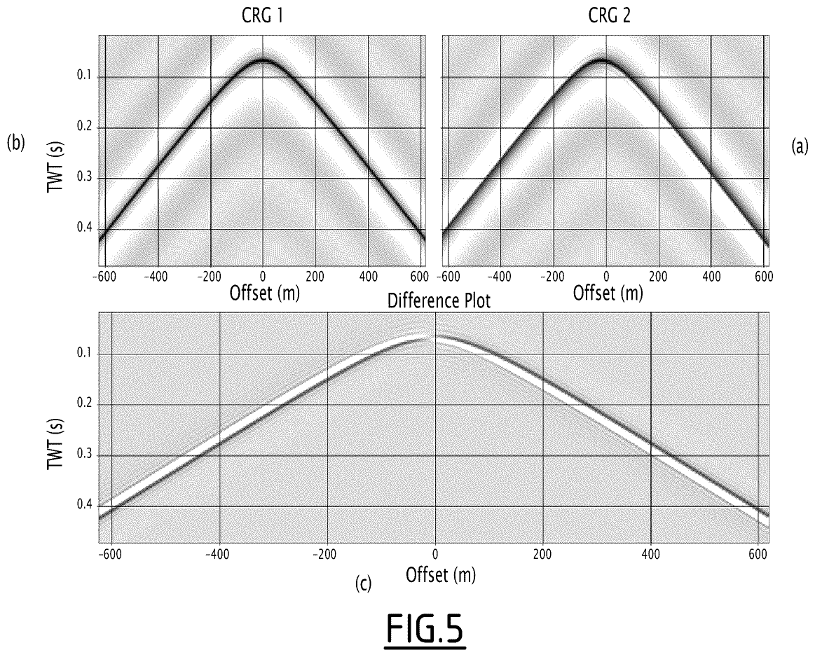

The reception time versus offset curve is plotted for example in FIG. 5, after a correlation with the pilot sweep has been carried out.

The curve (a) of FIG. 5 forms a common receiver gather 27 of a particular receiver 16, corresponding to the reception of successive reflected signals from successive sweeps of the source 14 moving with regard to the receiver 16 followed by a subsequent correlation with the pilot sweep.

The common receiver gather 27 shown in FIG. 5 comprises data which has been subjected to a Doppler effect. Indeed, since the source 14 is moving at a speed S with regards to the receiver 16, a phase rotation occurs with a direction of rotation depending on whether the sweep signature 21 is in a stretching regime (if the source 14 moves away from the receiver 16) or in a squeezing regime (if the source 14 moves towards a receiver 16). The phase rotation compared to a curve (b) simulated without Doppler effect is shown in curve (c) of FIG. 5.

In the example of FIG. 5, due to Doppler effect, the common receiver gather 27 is not symmetrical with regard to zero offset. On curve (c), a polarity reversal is visible over the apex, going from white to black on the left to black to white on the right.

As shown in FIG. 2, the installation 10 further comprises a seismic data processing system 30, to process data measured at each receiver 16. The processing system 30 is configured to implement the method according to the invention, in which a correction of the Doppler effect is carried out.

The processing system 30 comprises at least a computer having a processor 32 and a memory 34 containing software modules intended to be run by the processor 32.

The processing system 30 further comprises a display 36 for interacting with the processor 32, and for displaying results of the processing method and a man-machine interface 38, for example a keyboard and/or a mouse to control the processing system 30 and to input data in the processing system 30.

In a variant, the processing system 30 comprises field-programmable gate array (FGPA), or dedicated integrated circuits, to carry out the functions of the modules which are described below.

The processing system 30 comprises a retrieving module 40, configured to retrieve raw or pilot sweep correlated common receiver gathers acquired at each receiver 16, the common receiver gathers 27 resulting from reflections in the ground 20 of successive sweeps of the source 14 at various offsets between the receiver 16 and the source 14.

It comprises a first transforming module 42, configured to carry out a transform of the common receiver gather 27 in the time-offset domain to a grid of points (f, k) in a frequency-wavenumber domain.

The processing system 30 comprises a Doppler correction module 44 to calculate and apply a Doppler correction filter value at each point (f, k) of the grid in the frequency-wavenumber domain.

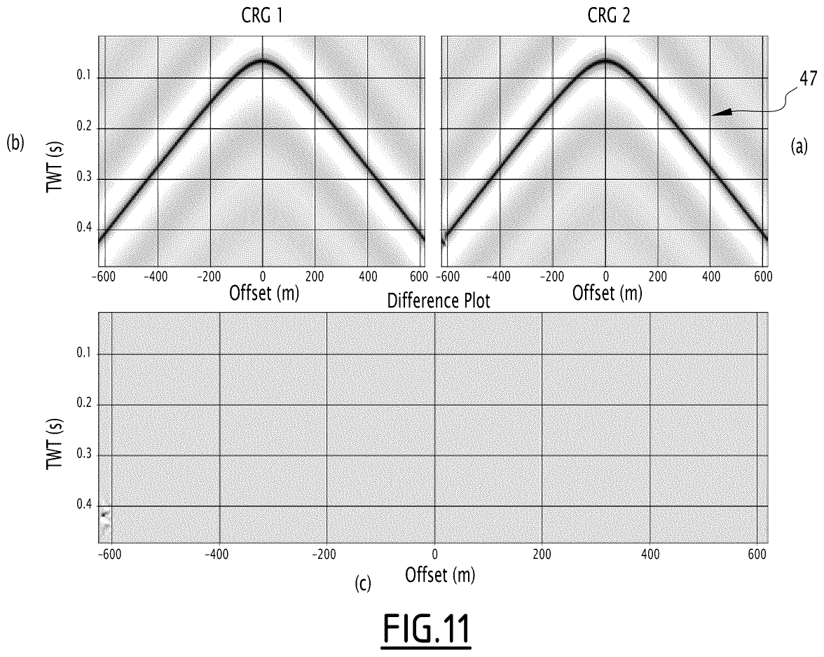

It comprises a second transforming module 46 to carry out an inverse transform of the grid in the frequency-wavenumber domain to the time-offset domain to obtain a corrected common receiver gather 47, an example of which is shown in curve (a) of FIG. 11.

The processing system 30 further comprises a processing module 48, configured to process the corrected common receiver gathers 47 of the receivers 16 to obtain at least a representation or/and a measurement of a ground feature.

A process of carrying out a seismic survey according to the invention will now be described.

In reference to FIG. 1, 3 or 4, receivers 16 are put in place in the body of water 12. The source 14 is programmed to execute successive sweeps according to a sweep signature 21. The sweep signature 21 can advantageously be non-analytically defined.

The sweep signature 21 is acquired by measuring the amplitude versus time curve of at least a sweep with a sensor of the source 14 or with an external sensor, as shown in FIG. 6.

The source 14 is then moved at the surface of the body of water 12 or in the body of water 12, while successive sweeps are emitted by the source 14.

The receivers 16 collect the acoustic signals resulting from reflections in the ground 20 of the sweep on ground features.

A raw common receiver gather is thus acquired at each receiver 16.

Then, the processing system 30 according to the invention is activated to carry out the processing method according to the invention.

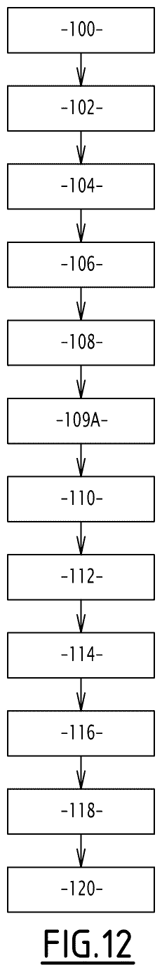

In reference to FIG. 12, at step 100, the retrieving module 40 retrieves data acquired by each of the receivers 16. Advantageously the data can be subsequently correlated with the pilot sweep to obtain common receiver gathers 27, an example of which is shown in curve (a) of FIG. 5, after correlation.

At step 102, the first transforming module 42 advantageously pads the data in time (for example with Os or with a reflection of the data) to avoid any edge effects induced by the transforms. It then carries out a f-k transform, in particular a Fourier transform, to transform the common receiver gather 27 and obtain a corresponding grid of points (f, k) in the frequency-wavenumber domain. A grid point (f, k) refers to the value of the 2D Fourier transformed common receiver gather at a given value of frequency f and wavenumber k.

The Doppler correction module 44 then calculates a Doppler correction filter to apply at each point (f, k) of the grid.

To this aim, at step 104, the Doppler correction module 44 retrieves the sweep signature 21 formed of the amplitude versus time curve of the sweep, as shown in FIG. 6. Then, at step 106, it calculates an instantaneous frequency versus time curve, defining an instantaneous frequency function, from the sweep signature 21.

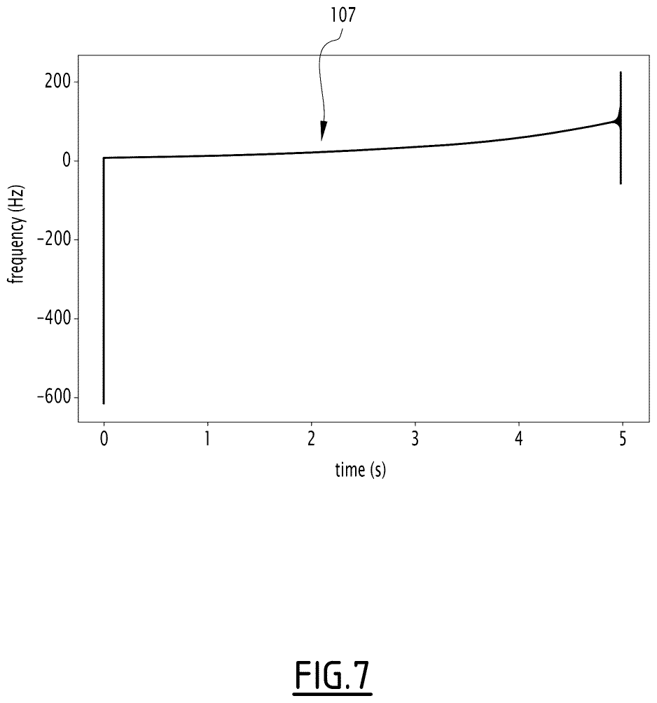

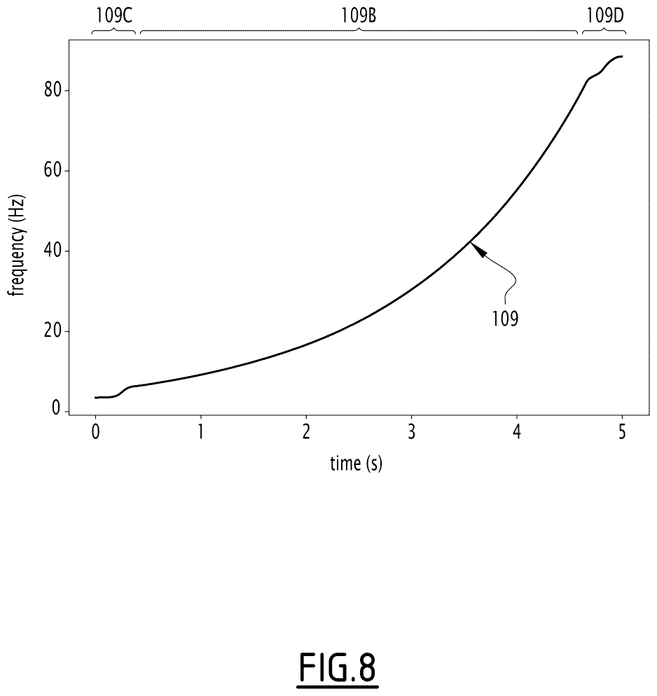

Advantageously, a raw instantaneous frequency versus time curve 107 is obtained as shown in FIG. 7. At step 108, the Doppler correction module 44 then filters the raw instantaneous frequency versus time curve 107, to delete edge effects and obtain a strictly monotonic filtered instantaneous frequency versus time curve, without any negative frequencies, forming the instantaneous frequency function 109 shown in FIG. 8.

The filter used by the Doppler correction module 44 is for example a Tukey filter which is applied to get a rolling average.

The size of the Tukey filter is dynamically selected to ensure that it is as small as possible to make the average robust and also large enough to ensure no negative frequencies or non-monotonic behavior is obtained.

Advantageously, at step 109A, the Doppler correction module 44 carries out an additional edge correction to obtain extrapolated edges of the instantaneous frequency function 109.

To this effect, the Doppler correction module 44 selects a medium region 109B of the instantaneous frequency function 109 (in this example between 0.5 s and 4.5 s) excluding at least one edge region 109C, 109D. It then carries out a fitting of the medium region 109B to a model monotonous function, for example an exponential, linear or polynomial function.

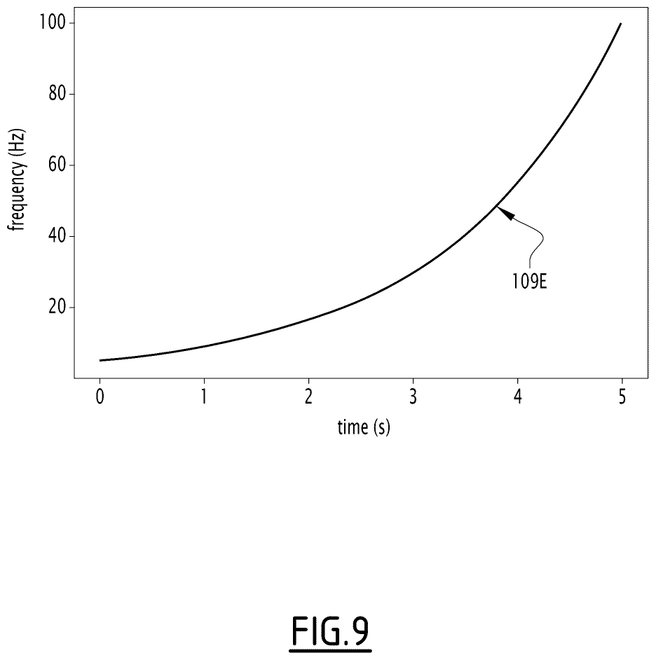

It then replaces the values of the instantaneous frequency function 109 at least in the or each edge region 109C, 109D, with corresponding values calculated from the model function, to obtain a corrected instantaneous frequency function 109E shown in FIG. 9.

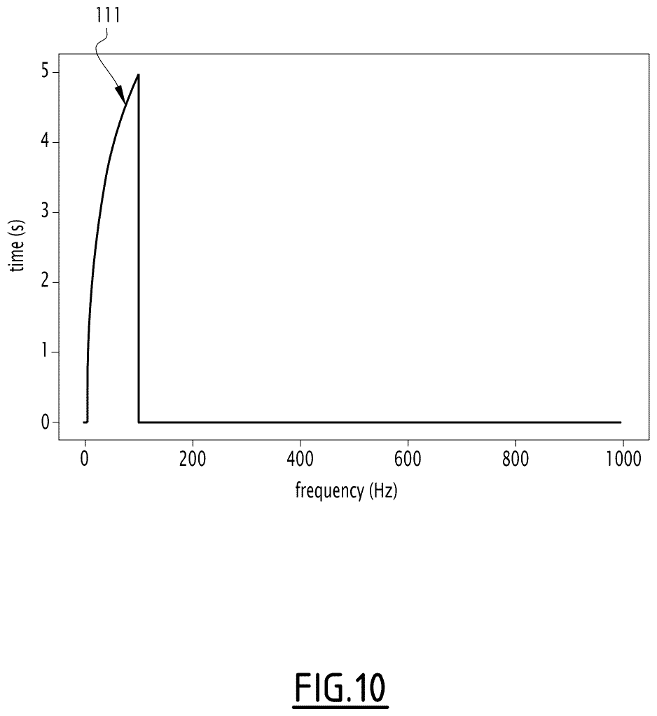

Once the corrected instantaneous frequency function 109E is obtained, at step 110, the Doppler correction module 44 inverts the instantaneous frequency function curve to form an inverse frequency function F⁻¹(f), shown as 111 in FIG. 10, which relates time as a function of frequency.

The inversion comprises swapping the x-axis from time to frequency and swapping the y-axis from frequency to time.

Inverting the instantaneous frequency function 109E comprises obtaining discrete inverse points of the inverse frequency function 111 from corresponding points of the instantaneous frequency function 109E.

Before swapping, the data points along the x-axis are generally sampled at regular time intervals dt. However, the data points along the y-axis may not be sampled regularly along the y-axis, for example when the frequency varies exponentially versus time

After swapping, the Doppler correction module 44 thus preferably extrapolates additional data points between adjacent discrete inverse points of the inverse frequency function 111 to fill in some gaps and obtain data points sampled at regular frequency intervals df. The value of df advantageously depends on the Nyquist frequency and on the number of time samples of the pilot sweep.

The inverse frequency function 111 thus obtained covers a given frequency range, from the starting sweep frequency to the ending sweep frequency.

At step 112, the Doppler correction module 44 completes the inverse frequency function outside of the given frequency range, by setting a nil value from 0 Hz to the starting sweep frequency and from the ending sweep frequency advantageously to the Nyquist frequency. The Nyquist frequency is dependent on the sampling frequency and is for example comprised between 500 Hz and 5000 Hz.

A complete inverse frequency function 111 is depicted in FIG. 10.

At step 114, the Doppler correction module 44 then calculates, for each grid point (f, k) having a wavenumber k and a frequency f, a Doppler correction filter value DF(f, k) associated to the grid point (f, k).

The Doppler correction filter value filter value DF(f, k) is preferably calculated by the following equation:

$$D F ( f , k ) = 2. π . S . k . {F}^{- 1} ( f ) , \qquad ( 1 )$$

where S is the source speed, k is the wavenumber, and F⁻¹(f) is the value of the inverse function 111 at the frequency f.

The Doppler correction filter value filter value DF(f, k) is here derived from the phase difference ΔΦ(t) between the Doppler shifted case and stationary case, as defined in the following equation:

$$Δ Φ ( t ) = Φ ( ( 1 + δ ) ( t ) ) - Φ ( t ) \qquad ( 2 )$$

δ is defined with the following equation:

$$δ = - S . p \qquad ( 3 )$$

in which S is the source speed and p is the ray parameter.

Due to the slow velocity S of the source compared to the water velocity, the Doppler factor δ is close to zero for any reflector and should be within a range of ±3×10⁻³.

Therefore, using a Taylor expansion of the Doppler factor around 0 truncated to the second order leads to the following equation:

$$Δ Φ ( t ) \approx 2 π δ t F ( t ) + 2 π \frac{{δ}^{2} {t}^{2} {F}^{′} ( t )}{2} \qquad ( 4 )$$

in which F(t) is the instantaneous frequency function of the signal (time derivative of the phase function).

The second term of equation (4) is generally small versus π/4, and is generally ignored.

As for the first term of equation (4), the phase difference is expressed as a function of time t, but if the instantaneous frequency function F(t) happens to be strictly monotonic, it can be written as in equation (1) as a function of the instantaneous frequency function itself through introduction of the inverse function F⁻¹(f) where f is instantaneous frequency and t is rewritten according to the following equation:

$$t = {F}^{- 1} ( f ) . \qquad ( 5 )$$

At step 116, for each grid point (f, k), the filter value DF(f, k) calculated for the grid point (f, k) is multiplied by the value of the grid point (f, k) in the frequency-wavenumber domain. As explained above, a grid point (f, k) refers to the value of the 2D Fourier transformed common receiver gather at a given value of frequency f and wavenumber k.

At step 118, the second transforming module 46 carries out an inverse transform of the filtered grid from the frequency-wavenumber domain to the time-offset domain to build a Doppler corrected common receiver gather 47 shown in curve (a) of FIG. 11. If a padding was added before the f-k transform (step 102), it is removed after the reverse transformation.

In the example of FIG. 11, the applied Doppler corrections render the common receiver gather 47 symmetrical with regard to zero offset, and the phase difference negligible (see curve (c)), ridding of the Doppler effect.

At step 120, the processing module 48 retrieves the corrected common receiver gathers 47 from all receivers 16, and applies a mathematical processing to obtain at least a representation or a measurement of a ground feature, for example a 2D or 3D map of boundaries 26 between geological layers in the ground 20.

The mathematical processing is known per se. Example of mathematical processing comprise converting the corrected common receiver gathers into common shot gathers and carrying out known seismic processes from this point. Example of mathematical processing are given in the reference book “Seismic Data Processing, Investigations in geophysics #2” by Özdoğan Yilmaz, ISBN 093183046X, 780931830464, edited by the Society of Exploration Geophysicists, 1987.

Based on the representation(s) or the measurement(s) of ground feature(s) obtained via the method according to the invention, in particular based on the geological map obtained, drilling of a well and/or exploitation of fluids in the ground 20 can be carried out taking into account the ground feature(s).

The method according to the invention uses the sweep signature 21 as a direct input which can be used to carry out the Doppler correction. Thus, contrary to the prior art techniques, it is not necessary to know or to determine an analytical definition of the sweep, and monotonic sweeps of various shapes can be used to excite the transducer of the source 14.

Moreover, the method according to the invention accommodates changes in theoretical versus practically outputted sweeps by inputting the actual excitation signal of the sweeps produced at the source 14.

As depicted in curves (a) and (c) of FIG. 11, in comparison to curve (a) and (c) of FIG. 5, the processing method according to the invention is able to reliably and efficiently correct a Doppler effect, directly from the sweep signature 21, without having to derive a mathematical expression for the Doppler correction of a given sweep type.

The method according to the invention therefore provides a very reliable use of a marine vibrator, which is a very environmentally friendly method, while keeping the accuracy of the processing.

In the case of FIG. 4, in which the receivers 16 are also moving, the process according to the invention is preferably applied to the data after implementing receiver motion correction. The correction applies to the Doppler effect related to the source 14.

In a variant, a preprocessing of the raw common receiver gather 27 is applied before applying the Doppler correction or on the contrary, is applied to the corrected common receiver gather 47 after applying the Doppler correction.

This gives flexibility to the processing method according to the invention, in particular for interpolating additional seismic traces. In that case, the raw common receiver gather 27 data is correlated with the pilot sweep, extra traces are interpolated and the Doppler correction of the method according to the invention is carried out after the latter preprocessing. This kind of preprocessing would not be operable with a known 2D Doppler shift correction.

In another variant, the sweep signature 21 is not measured, but is reconstructed by simulation from other information such as parameters of the emitted sweep. The reconstructed sweep signature 21 is then used as an input to the Doppler correction module 48, as described above.

1. A seismic data processing method, carried out using a seismic data processing system, the seismic data being data received by at least one receiver during a relative movement of a vibratory seismic source with regards to the at least one receiver, the method comprising:
retrieving at least one common receiver gather acquired at the at least one receiver, the common receiver gather resulting from reflections in a ground of successive sweeps emitted by the source, the successive sweeps being emitted at different offsets between the at least one receiver and the source; and for the at least one common receiver gather;
transforming the at least one common receiver gather in the time-offset domain to obtain a grid in a frequency-wavenumber domain, the grid having a plurality of points;
calculating and applying a Doppler correction filter value at each point of the grid in the frequency-wavenumber domain;
inverse transforming the grid in the frequency-wavenumber domain to the time-offset domain to obtain at least one Doppler corrected common receiver gather;
processing the at least one Doppler corrected common receiver gather to obtain at least a representation or/and a measurement of at least a ground feature using the at least one Doppler corrected common receiver gather; and
calculating and applying a Doppler correction filter value comprising determining an instantaneous frequency function of at least one of the sweeps emitted by the source, inverting the instantaneous frequency function to obtain an inverse frequency function, and calculating the Doppler correction filter value from the inverse frequency function.

2. The method according to claim 1, wherein the sweeps are monotonic with respect to time and frequency.

3. The method according to claim 1, wherein the sweeps lack an analytical definition.

4. The method according to claim 1, wherein determining an instantaneous frequency function comprises retrieving a measured or reconstructed sweep signature including an amplitude of a seismic emission signal as a function of time during the sweep, and determining the instantaneous frequency function from the measured or reconstructed sweep signature.

5. The method according to claim 4, wherein the sweep signature is a measured sweep signature, measured during the actual sweep emission from a sensor within the source, or/and from a sensor external to the source.

6. The method according to claim 1, wherein calculating and applying a Doppler correction filter value comprises applying a filter to a raw instantaneous frequency function to remove non monotonic behavior and negative frequencies.

7. The method according to claim 1, wherein calculating and applying a Doppler correction filter value comprises carrying out an additional edge correction to the instantaneous frequency function to obtain at least an extrapolated edge of the instantaneous frequency function.

8. The method according to claim 1, wherein inverting the instantaneous frequency function comprises inverting the instantaneous frequency function in a given frequency range ranging from a starting sweep frequency to an ending sweep frequency, and setting a nil value to the inverse frequency function, outside of the given frequency range.

9. The method according to claim 1, wherein inverting the instantaneous frequency function comprises obtaining discrete inverse points of the inverse frequency function from corresponding points of the instantaneous frequency function and extrapolating additional points between at least two adjacent discrete inverse points of the inverse frequency function.

10. The method according to claim 1, wherein the Doppler correction filter value is calculated from a relative speed of movement of the source with regards to the at least one receiver.

11. The method according to claim 10, wherein the Doppler correction filter value is calculated at each point (f, k) of the grid via the equation 2.π.S.k.F⁻¹(f); where S is the source speed, k is the wavenumber at the point (f, k), f is the frequency at the point (f, k) and F⁻¹(f) is the value of the inverse frequency function at the frequency f at the point (f, k).

12. The method according to claim 1, comprising pre-processing the common receiver gather before and/or after applying the Doppler correction filter value and before processing the at least one Doppler corrected common receiver gather.

13. A seismic survey process, comprising:
moving a vibratory seismic source in relation to at least one receiver;
emitting successive sweeps via the source;
acquiring at the at least one receiver, a common receiver gather from the successive sweeps;
carrying out the method according to claim 1.

14. The process according to claim 13, wherein the source is moved at the surface or in a body of water, the at least one receiver laying on a bottom of the body of water or floating in the body of water, the at least one ground feature being below the bottom of the body of water.

15. A seismic data processing system configured to process seismic data, the seismic data being received by at least one receiver during a relative movement of a vibratory seismic source with regards to the at least one receiver, the system comprising at least a calculator configured to:
a retrieving module configured to retrieve at least a common receiver gather acquired at the at least one receiver, the common receiver gather resulting from reflections in a ground of successive sweeps emitted by the source, the successive sweeps being emitted at different offsets between the at least one receiver and the source;
transform the at least one common receiver gather in the time-offset domain to obtain a grid in a frequency-wavenumber domain, the grid having a plurality of points;
calculate and apply a Doppler correction filter value at each point of the grid in the frequency-wavenumber domain;
inverse transform the grid in the frequency-wavenumber domain to the time-offset domain to obtain a Doppler corrected common receiver gather;
process the Doppler corrected common receiver gather to obtain at least a representation or/and a measurement of at least a ground feature using the or each Doppler corrected common receiver gather;
the at least one calculator being configured to determine an instantaneous frequency function of at least one of the sweeps emitted by the source, to invert the instantaneous frequency function to obtain an inverse frequency function, and to calculate the Doppler correction filter value from the inverse frequency function.

16. A seismic acquisition installation comprising:
a vibratory seismic source, configured to emit successive sweeps;
at least one receiver, configured to acquire at least a common receiver gather resulting from reflections in a ground of successive sweeps emitted by the source, the vibratory seismic source being movable with regards to the at least one receiver to emit the successive sweeps at different offsets between the at least one receiver and the source;
a data processing system according to claim 15.

17. The method according to claim 5, wherein the sweep signature is a measured sweep signature, measured during the actual sweep emission from an accelerometer or a piston movement measuring sensor, or/and a near field hydrophone.
